(19) United States
(12) Patent Application Publication
(10) Pub. No.: US 2026/0061731 A1
(43) Pub. Date: Mar. 5, 2026

(54) ANTISTATIC COMPOSITE BOARD AND METHOD FOR PRODUCING THE SAME

(71) Applicant: NAN YA PLASTICS CORPORATION, TAIPEI (TW)

(72) Inventors: CHING-YAO YUAN, TAIPEI (TW); CHUN-CHE TSAO, TAIPEI (TW); PEI-YU CHIANG, TAIPEI (TW)

(21) Appl. No.: 18/953,736

(22) Filed: Nov. 20, 2024

(30) Foreign Application Priority Data
Sep. 3, 2024 (TW) 113133164

(51) Int. Cl. B32B 27/08; B32B 27/36; B32B 37/16

(52) U.S. Cl. CPC B32B 27/08; B32B 27/36; B32B 37/16; B32B 2255/10; B32B 2255/26; B32B 2307/21; B32B 2307/412; B32B 2307/414; B32B 2307/7376; B32B 2367/00

(57) ABSTRACT

An antistatic composite board and method for producing the same are provided. The antistatic composite board includes a PET substrate, a PET film, and a coating layer formed by coating a coating liquid onto the PET film. The coating liquid includes a polyurethane oligomer, an antistatic agent, and a solvent. The antistatic agent includes a first dispersant and a plurality of carbon nanotubes. Based on a total weight of the coating liquid being 100 wt %, a content of the polyurethane oligomer is between 30 wt % and 40 wt %, a content of the antistatic agent is 5 wt % and 20 wt %, and a content of the solvent is 40 wt % and 60 wt %. The antistatic composite board has a light transmittance of not less than 84%, a haze of not greater than 4%, and a surface specific impedance of not greater than 10702.

### CROSS-REFERENCE TO RELATED PATENT APPLICATION

This application claims the benefit of priority to Taiwan Patent Application No. 113133164, filed on Sep. 3, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a composite board and method for producing the same, and more particularly to an antistatic composite board and method for producing the same.

### BACKGROUND OF THE DISCLOSURE

A conventional antistatic board has an organic antistatic agent added thereto for increasing an antistatic property, but the organic antistatic agent has a poor heat resistance and cannot provide a long-lasting antistatic property. Other conventional antistatic boards may have an inorganic antistatic agent added thereto, but the inorganic antistatic agent has a poor dispersion, which can easily affect an optical property of these antistatic boards.

### SUMMARY OF THE DISCLOSURE

In response to the above-referenced technical inadequacy, the present disclosure provides antistatic composite board and method for producing the same, so as to effectively improve on a conventional antistatic board having an optical property that is affected by the addition of inorganic antistatic agent having poor dispersion.

In order to solve the above-mentioned problems, one of the technical aspects adopted by the present disclosure is to provide an antistatic composite board. The antistatic composite board includes a PET substrate, a PET film, and a coating layer. The PET film is formed on one side of the PET substrate. The coating layer is formed by coating a coating liquid on one side of the PET film away from the PET substrate. The coating liquid has a viscosity of between 20 cps and 40 cps, and the coating liquid includes a polyurethane oligomer, an antistatic agent, and a solvent. The antistatic agent includes a first dispersant and a plurality of carbon nanotubes dispersed in the first dispersant, and a weight ratio between the carbon nanotubes and the first dispersant is between 99:1 and 99.9:0.1. The solvent is propylene glycol methyl ether acetate (PMA). Based on a total weight of the coating liquid being 100 wt %, a content of the polyurethane oligomer is between 30 wt % and 40 wt %, a content of the antistatic agent is between 5 wt % and 20 wt %, and a content of the solvent is between 40 wt % and 60 wt %. The antistatic composite board has a light transmittance of greater than or equal to 84%, a haze of less than or equal to 4%, and a surface specific impedance of less than or equal to 10702.

In one of the possible or preferred embodiments, a thickness of the PET substrate is between 1.5 mm and 2.5 mm, a thickness of the PET film is between 60 μm and 150 μm, and a thickness of the coating layer is between 2 μm and 8 μm.

In one of the possible or preferred embodiments, a length of each of the carbon nanotubes is between 5 μm and 8 μm, and a diameter of each of the carbon nanotubes is between 1.2 nm and 2 nm.

In one of the possible or preferred embodiments, the antistatic composite board further includes a photoinitiator and a second dispersant. Based on the total weight of the coating liquid being 100 wt %, a content of the photoinitiator is between 0.1 wt % and 2 wt %, and a content of the second dispersant is between 0.1 wt % and 3 wt %. The photoinitiator is 1-hydroxycyclohexylbenzophenone, and the second dispersant is selected from the group consisting of styrene maleic anhydride copolymer and alkaline polymer pigment dispersant.

In one of the possible or preferred embodiments, the antistatic composite board includes two PET films and two coating layers, the two PET films are disposed at two sides of the PET substrate, and each of the coating layers is disposed at one side of one of the PET films away from the PET substrate.

In order to solve the above-mentioned problems, another one of the technical aspects adopted by the present disclosure is to provide a method for producing an antistatic composite board. The method includes a mixing process, a coating process, and a thermal pasting process. The mixing process is implemented by adding a polyurethane oligomer and an antistatic agent into a solvent and stirring at a stirring speed of between 600 rpm and 1,000 rpm for 5 minutes to 15 minutes to form a coating liquid. The coating liquid has a viscosity of between 20 cps and 40 cps. The antistatic agent includes a first dispersant and a plurality of carbon nanotubes dispersed in the first dispersant, and a weight ratio between the carbon nanotubes and the first dispersant is between 99:1 and 99.9:0.1. The coating process is implemented by coating the coating liquid onto a PET film to form a coating layer on one side of the PET film. The thermal pasting process is implemented by pasting the PET film having the coating layer formed thereon onto a PET substrate at a temperature of between 40° C. and 70° C., so as to form an antistatic composite board. The solvent is propylene glycol methyl ether acetate (PMA). Based on a content of the total weight being 100 wt %, a content of the polyurethane oligomer is between 30 wt % and 40 wt %, a content of the antistatic agent is between 5 wt % and 20 wt %, and a content of the solvent is between 40 wt % and 60 wt %. The antistatic composite board has a light transmittance of greater than or equal to 84%, a haze of less than or equal to 4%, and a surface specific impedance of less than or equal to 10⁷Ω.

In one of the possible or preferred embodiments, in the mixing process, a photoinitiator and a second dispersant are added. Based on the total weight of the coating liquid being 100 wt %, a content of the photoinitiator is between 0.1 wt % and 2 wt %, and a content of the second dispersant is between 0.1 wt % and 3 wt %. The photoinitiator is 1-hydroxycyclohexylbenzophenone, and the second dispersant is selected from the group consisting of styrene maleic anhydride copolymer and alkaline polymer pigment dispersant.

In one of the possible or preferred embodiments, after the coating process and before the thermal pasting process, the method further includes a photocuring process implemented by photocuring the PET film having the coating layer formed thereon with a light intensity of between 500 mJ/cm² and 1000 mJ/cm².

In one of the possible or preferred embodiments, a length of each of the carbon nanotubes is between 5 μm and 8 μm, and a diameter of each of the carbon nanotubes is between 1.2 nm and 2 nm.

In one of the possible or preferred embodiments, a thickness of the PET substrate is between 1.5 mm and 2.5 mm, a thickness of the PET film is between 60 μm and 150 μm, and a thickness of the coating layer is between 2 μm and 8 μm.

Therefore, in the method for producing a circuit board provided by the present disclosure, by virtue of “based on the total weight of the coating liquid being 100 wt %, the content of the polyurethane oligomer being between 30 wt % and 40 wt %, the content of the antistatic agent being between 5 wt % and 20 wt %, and the content of the solvent being between 40 wt % and 60 wt %” and “the antistatic agent including the first dispersant and the carbon nanotubes dispersed in the first dispersant, and the weight ratio between the carbon nanotubes and the first dispersant being between 99:1 and 99.9:0.1,” the conventional antistatic board having the optical property that is affected by the addition of inorganic antistatic agent having poor dispersion can be effectively improved.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of an antistatic composite board according to one embodiment of the present disclosure;

FIG. 2 is a schematic view of an antistatic composite board according to another embodiment of the present disclosure;

FIG. 3 is a flowchart of a method for producing an antistatic composite board according to one embodiment of the present disclosure;

FIG. 4 is a flowchart of the method for producing the antistatic composite board according to another embodiment of the present disclosure; and

FIG. 5 is a flowchart of the method for producing the antistatic composite board according to another embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### Antistatic Composite Board

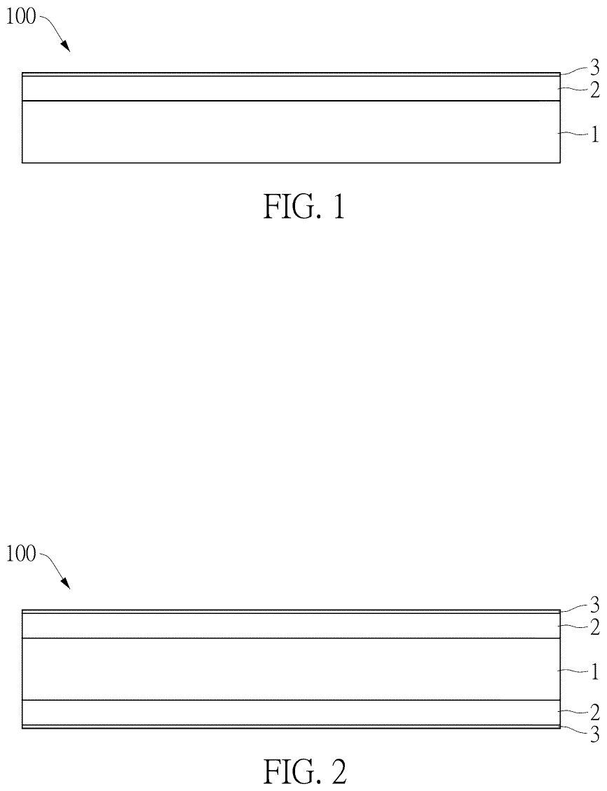

Referring to FIG. 1, FIG. 1 is a schematic view of an antistatic composite board according to one embodiment of the present disclosure. An embodiment of the present disclosure provides a method for producing an antistatic composite board 100. The antistatic composite board 100 includes a PET substrate 1, a PET film 2, and a coating layer 3. The PET film 2 is formed on one side of the PET substrate 1, and the coating layer 3 is formed by coating a coating liquid onto one side of the PET film 2 away from the PET substrate 1. The coating liquid has a viscosity of between 20 cps and 40 cps.

In the present disclosure, the PET substrate 1 can be formed by extruding PET masterbatch made by Nan Ya (model no.: 3842) with a extruder, and the temperatures of five sections of the extruder are 250° C., 260° C., 260° C., 260° C., and 260° C., respectively. After being extruded, the PET substrate 1 can be cooled down by a first forming wheel, a second forming wheel, and a third forming wheel and can be formed with a guiding wheel having a guiding speed of 1 m/minute. A temperature of the first forming wheel can be within 35° C. and 45° C. (preferably, 40° C.), a temperature of the second forming wheel can be within 35° C. and 45° C. (preferably, 40° C.), and a temperature of the third forming wheel can be within 60° C. and 70° C. (preferably, 65° C.). In addition, the PET film 2 can be a PET film made by Nan Ya (model no.: LL226), but the present disclosure is not limited thereto.

In the present embodiment, a thickness of the PET substrate 1 is between 1.5 mm and 2.5 mm, a thickness of the PET film 2 is between 60 μm and 150 μm, and a thickness of the coating layer 3 is between 2 μm and 8 μm, but the present disclosure is not limited thereto. Preferably, the thickness of the PET substrate 1 is between 1.8 mm and 2.2 mm, the thickness of the PET film 2 is between 80 μm and 125 μm, and the thickness of the coating layer 3 is between 4 μm and 6 μm.

The coating liquid includes a polyurethane oligomer, an antistatic agent, and a solvent. The polyurethane oligomer is propylene glycol methyl ether acetate (PMA). Based on a total weight of the coating liquid being 100 wt %, a content of the polyurethane oligomer is between 30 wt % and 40 wt %, a content of the antistatic agent is between 5 wt % and 20 wt %, and a content of the solvent is between 40 wt % and 60 wt %. Preferably, based on a total weight of the coating liquid being 100 wt %, the content of the polyurethane oligomer is between 32.5 wt % and 37.5 wt %, the content of the antistatic agent is between 10 wt % and 20 wt %, and the content of the solvent is between 45 wt % and 55 wt %.

The polyurethane oligomer can be polyurethane acrylate oligomer (e.g., model no. TJ-UA2001 made by TONG YA SYNTHETIC RESIN FACTORY CO., LTD.). The antistatic agent includes a first dispersant and a plurality of carbon nanotubes dispersed in the first dispersant, and a weight ratio between the carbon nanotubes and the first dispersant is between 95:5 and 99.9:0.1. Preferably, the weight ratio between the carbon nanotubes and the first dispersant is between 99:1 and 99.9:0.1.

In other words, the carbon nanotubes can be dispersed in the first dispersant in advance, such that the carbon nanotubes can be preferably dispersed in the coating liquid. The first dispersant can be, for example, propylene glycol methyl ether acetate (PMA), but the present disclosure is not limited thereto. In addition, the first dispersant and the solvent can be of the same material, such that the antistatic agent can be preferably dispersed in the coating liquid.

In the present embodiment, a length of each of the carbon nanotubes is between 5 μm and 8 μm, and a diameter of each of the carbon nanotubes is between 1.2 nm and 2 nm. Preferably, the length of each of the carbon nanotubes is between 5.5 μm and 7.5 μm, and the diameter of each of the carbon nanotubes is between 1.4 nm and 1.8 nm. In other words, an average length of the carbon nanotubes is between 5 μm and 8 μm, and an average diameter of the carbon nanotubes is between 1.2 nm and 2 nm. Preferably, the average length of the carbon nanotubes is between 5.5 μm and 7.5 μm, and the average diameter of the carbon nanotubes is between 1.4 nm and 1.8 nm. The carbon nanotubes can be MATRIX 208 made by TUBLALL™, but the present disclosure is not limited thereto.

The coating liquid can further include a photoinitiator and a second dispersant. Based on the total weight of the coating liquid being 100 wt %, a content of the photoinitiator is between 0.1 wt % and 2 wt %, and a content of the second dispersant is between 0.1 wt % and 3 wt %. In the present embodiment, the photoinitiator is 1-hydroxycyclohexylbenzophenone, and the second dispersant is selected from the group consisting of styrene maleic anhydride copolymer (e.g., BYK-2013) and alkaline polymer pigment dispersant (e.g., PB821 made by Japanese Ajinomoto), but the present disclosure is not limited thereto.

The antistatic composite board 100 has a light transmittance of greater than or equal to 84%, a haze of less than or equal to 4%, and a surface specific impedance of less than or equal to 1072. Preferably, in the antistatic composite board 100, the light transmittance is between 84% and 88%, and the haze is between 1% and 4%.

Referring to FIG. 2, FIG. 2 is a schematic view of an antistatic composite board according to another embodiment of the present disclosure. The antistatic composite board 100 includes two PET films 2 and two coating layers 3, the two PET films 2 are disposed at two sides of the PET substrate 1, and each of the coating layers 3 is disposed at one side of one of the PET films 2 away from the PET substrate 1.

### Method for Producing an Antistatic Composite Board

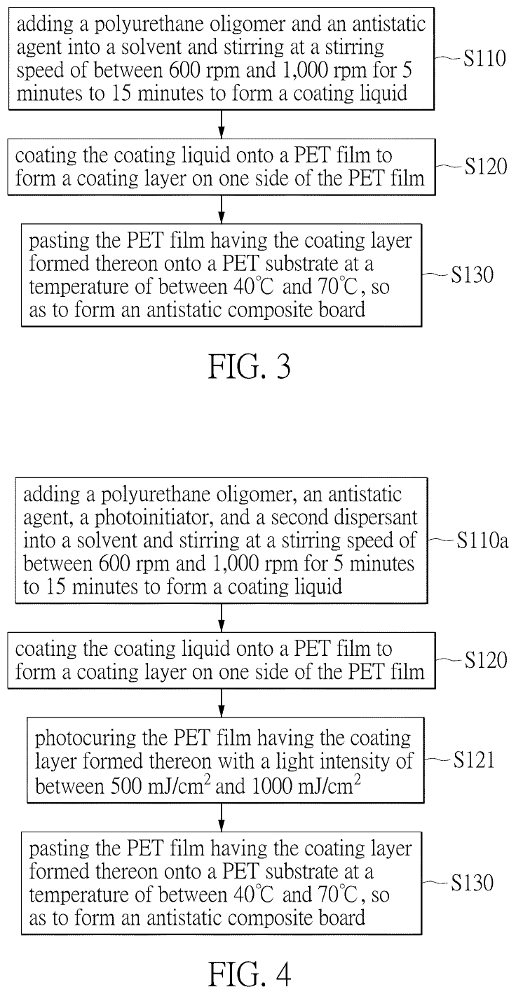

Referring to FIG. 3, FIG. 3 is a flowchart of a method for producing an antistatic composite board according to one embodiment of the present disclosure. The embodiment of the present disclosure further provides a method for producing an antistatic composite board. The above-mentioned antistatic composite board 100 can be obtained by implementing the method for producing the antistatic composite board, but the present disclosure is not limited thereto. The method for producing the antistatic composite board includes a mixing process S110, a coating process S120, and a thermal pasting process S130. Naturally, the method for producing the antistatic composite board can include other processes according to practical requirements, but the present disclosure is not limited thereto.

The mixing process S110 is implemented by adding a polyurethane oligomer and an antistatic agent into a solvent and stirring at a stirring speed of between 600 rpm and 1,000 rpm for 5 minutes to 15 minutes to form a coating liquid. Preferably, in the mixing process S110, the polyurethane oligomer, the antistatic agent, and the solvent are stirred at a stirring speed of between 700 rpm and 900 rpm (more preferably, 800 rpm). The coating liquid has a viscosity of between 20 cps and 40 cps under an operation temperature (e.g., under a room temperature). The solvent is propylene glycol methyl ether acetate (PMA). Based on a total weight of the coating liquid being 100 wt %, a content of the polyurethane oligomer is between 30 wt % and 40 wt %, a content of the antistatic agent is between 5 wt % and 20 wt %, and a content of the solvent is between 40 wt % and 60 wt %.

Preferably, in the mixing process S110, the polyurethane oligomer and one portion of the solvent can be mixed to form a first solution, the antistatic agent and another portion of the solvent can be mixed to formed a second solution, and the first solution and the second solution can be mixed and then stirred at the mixing speed of between 600 rpm and 1,000 rpm for 5 minutes to 15 minutes to form the coating liquid. In addition, a weight ratio between the solvent in the first solution and the solvent in the second solution can be between 1:1.5 and 1.5:1, but the present disclosure is not limited thereto.

The antistatic agent includes a first dispersant and a plurality of carbon nanotubes dispersed in the first dispersant, and a weight ratio between the carbon nanotubes and the first dispersant is between 99:1 and 99.9:0.1. A length of each of the carbon nanotubes is between 5 μm and 8 μm, and a diameter of each of the carbon nanotubes is between 1.2 nm and 2 nm.

Referring to FIG. 4, FIG. 4 is a flowchart of the method for producing the antistatic composite board according to another embodiment of the present disclosure. In the mixing process S110a of another embodiment, a photoinitiator and a second dispersant are added. Based on the total weight of the coating liquid being 100 wt %, a content of the photoinitiator is between 0.1 wt % and 2 wt %, and a content of the second dispersant is between 0.1 wt % and 3 wt %. The photoinitiator is 1-hydroxycyclohexylbenzophenone, and the second dispersant is selected from the group consisting of styrene maleic anhydride copolymer and alkaline polymer pigment dispersant. More specifically, the photoinitiator can be added in the first solution, the second dispersant can be added in the second solution, and the first solution and the second solution can be mixed and stirred to form the coating liquid. In this way, the antistatic agent can be preferably dispersed in the coating liquid.

The coating process S120 is implemented by coating the coating liquid onto a PET film 2 to form a coating layer 3 on one side of the PET film 2. The thermal pasting process S130 is implemented by pasting the PET film 2 having the coating layer 3 formed thereon onto a PET substrate 1 at a temperature of between 40° C. and 70° C., so as to form an antistatic composite board 100. A thickness of the PET substrate 1 is between 1.5 mm and 2.5 mm, a thickness of the PET film 2 is between 60 μm and 150 μm, and a thickness of the coating layer 3 is between 2 μm and 8 μm.

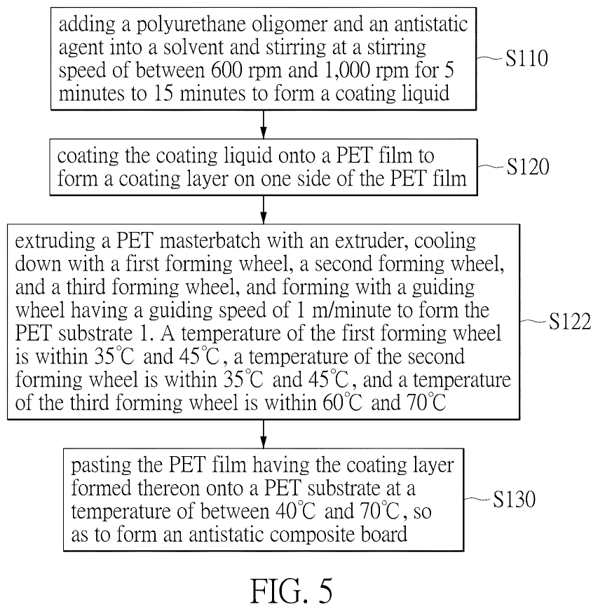

Referring to FIG. 5, FIG. 5 is a flowchart of the method for producing the antistatic composite board according to another embodiment of the present disclosure. In one embodiment, after the coating process S120 and before the thermal pasting process S130, the method for producing the antistatic composite board can further include a photocuring process S121 implemented by photocuring the PET film 2 having the coating layer 3 formed thereon with a light intensity of between 500 mJ/cm² and 1000 mJ/cm².

In addition, before the thermal pasting process S130, the method for producing the antistatic composite board can further include an extruding and forming process S122 implemented by extruding a PET masterbatch with an extruder, cooling down with a first forming wheel, a second forming wheel, and a third forming wheel, and forming with a guiding wheel having a guiding speed of 1 m/minute to form the PET substrate 1. A temperature of the first forming wheel is within 35° C. and 45° C. (preferably, 40° C.), a temperature of the second forming wheel is within 35° C. and 45° C. (preferably, 40° C.), and a temperature of the third forming wheel is within 60° C. and 70° C. (preferably, 65° C.). The temperatures of five sections of the extruder are 250° C., 260° C., 260° C., 260° C., and 260° C., respectively.

The antistatic composite board 100 obtained by implementing the method for producing the antistatic composite board has a light transmittance of greater than or equal to 84%, a haze of less than or equal to 4%, and a surface specific impedance of less than or equal to 10702.

### Experimental Results

The components and test results of Exemplary Example and Comparative Examples are listed in Table 1 below, procedure parameters of the Exemplary Example and Comparative Examples are listed in Table 2 below, light irradiation test results of the Exemplary Example is listed in Table 3 below, and relevant testing methods are described as follows.

Haze test is carried out by using a haze meter (model: NDK NDH7000) according to the ASRMD-1003 test standard.

Surface specific impedance test is carried out by using a surface resistivity tester (model: OHM-STAT RT-1000) according to the ASTMD-257 test standard.

Light transmittance test is carried out by using a haze meter (model: NDK NDH7000) according to the ASRMD-1003 test standard.

Thickness is measured by using a magnetic film thickness gauge (model: KETT LZ-990).

Pencil hardness test is carried out by using a pencil hardness tester (model: B-3084T3) according to the JIS K 5400 test standard.

Wipe resistance test is carried out by using a wear testing machine (model: A20-339) in the following two manners: (1) using dust-free wipe cloth with 1 kg pressure and 50% IPA to wipe back and forth 1500 times to test the solvent resistance; and (2) wiping back and forth for 1500 times with #0000 steel wool to test steel wool resistance.

Aging test is carried out by irradiating the samples with different light sources with Cofomegra UV accelerated aging tester and then analyzing the optical properties of the samples.

TABLE 1
Components of Exemplary Example and Comparative Examples and
Test Results of Their Physical and Chemical Properties

| | | Comparative | Comparative | Comparative | Comparative |
|---|---|---|---|---|---|
| Item | | Example 1 | Example 2 | Example 3 | Example 4 |
| Solvent | IPA | 64% | | | |
| | MEK | | 64% | | |
| | EAC | | | 64% | |
| | water | | | | 64% |
| Oligomer | Polyurethane | 20% | 20% | 20% | 20% |
| Photoinitiator | I184 | 1% | 1% | 1% | 1% |
| Antistatic | Tin antimony | 15% | 15% | 15% | 15% |
| agent | oxide particle | | | | |
| | (SP2002) | | | | |

| | | | | |
|---|---|---|---|---|
| Coating liquid appearance | pass | precipite | precipite | pass |
| Light transmittance (%) | 89.18 | 88.55 | 89.57 | 89.35 |
| Haze (%) | 27.21 | 50.40 | 51.07 | 31.35 |
| Surface specific impedance (Ω) | 10⁹ | 10⁷ | 10⁸ | 10⁸ |
| Surface specific impedance | 10¹² | 10¹¹ | 10¹¹ | 10¹¹ |
| (Ω) after wiped with solvent | | | | |
| Surface specific impedance | 10¹² | 10¹¹ | 10¹¹ | 10¹² |
| (Ω) after wiped with steel wool | | | | |
| Pencil hardness | HB | HB | HB | HB |
| Film appearance | poor | poor | poor | poor |

| | | Comparative | Comparative | Comparative | Comparative |
|---|---|---|---|---|---|
| Item | | Example 5 | Example 6 | Example 7 | Example 8 |
| Solvent | EAC | 49% | 49% | 49% | |
| | PMA | | | | 49% |
| Oligomer | Polyurethane | 35% | 35% | 35% | 35% |
| | acrylic | | | | |
| Photoinitiator | I184 | 1% | 1% | 1% | 1% |
| Antistatic | Tin antimony | 15% | | | |
| agent | oxide particle | | | | |
| | (SP2002) | | | | |
| | Ionic liquid | | 15% | | |
| | (AS100) | | | | |
| | Carbon nanotube | | | 15% | 15% |
| | (TUBALL) | | | | |

| | | | | |
|---|---|---|---|---|
| Coating liquid appearance | gather | pass | slightly gather | slightly gather |
| Light transmittance (%) | 88.30 | 86.30 | 82.52 | 84.52 |
| Haze (%) | 35.20 | 3.20 | 2.45 | 2.02 |
| Surface specific impedance (Ω) | 10⁸ | 10⁹ | 10⁷ | 10⁷ |
| Surface specific impedance | 10¹¹ | 10¹² | 10⁸ | 10⁸ |
| (Ω) after wiped with solvent | | | | |
| Surface specific impedance | 10¹² | 10¹² | 10⁸ | 10⁸ |
| (Ω) after wiped with steel wool | | | | |
| Pencil hardness | 2H | 2H | 2H | 2H |
| Film appearance | normal | good | normal | normal |

| | | Comparative | Comparative | Comparative | Comparative | Exexplary |
|---|---|---|---|---|---|---|
| Item | | Example 9 | Example 10 | Example 11 | Example 12 | Example 1 |
| Solvent | EAC | 48.5% | 49% | 49% | | |
| | PMA | | | | 49% | 48% |
| Oligomer | Polyurethane | 35% | 35% | 35% | 35% | 35% |
| | acrylic | | | | | |
| Photoinitiator | I184 | 1% | 1% | 1% | 1% | 1% |
| Antistatic | Carbon nanotube | 15% | 15% | 15% | 15% | 15% |
| agent | (TUBALL) | | | | | |
| Additives | BYK-154 | 0.5% | | | | |
| | BYK-UV3575 | | 0.5% | | | |
| | BYK-2013 | | | 0.5% | | 0.5% |
| | PB821 | | | | 0.5% | 0.5% |

| | | | | | |
|---|---|---|---|---|---|
| Coating liquid appearance | slightly gather | slightly gather | pass | pass | pass |
| Light transmittance (%) | 82.4 | 83.41 | 85.50 | 85.81 | 86.06 |
| Haze (%) | 2.08 | 1.75 | 2.51 | 1.99 | 1.59 |
| Surface specific impedance (Ω) | 10⁹ | 10⁷ | 10⁷ | 10⁷ | 10⁷ |
| Surface specific impedance | 10¹¹ | 10¹⁰ | 10⁸ | 10⁸ | 10⁸ |
| (Ω) after wiped with solvent | | | | | |
| Surface specific impedance | 10¹² | 10¹¹ | 10⁸ | 10⁸ | 10⁸ |
| (Ω) after wiped with steel wool | | | | | |
| Pencil hardness | 2H | 2H | 2H | 2H | 2H |
| Film appearance | normal | normal | normal | normal | good |

TABLE 2
[Processing parameter of Exemplary Example and Comparative Examples]

| | Comparative | Comparative | Comparative | Comparative | Exexplary |
|---|---|---|---|---|---|
| Item | Example 1 | Example 2 | Example 3 | Example 4 | Example 1 |
| Temperature of | 40 | 40 | 40 | 40 | 40 |
| first forming wheel | | | | | |
| (° C.) | | | | | |
| Temperature of | 40 | 40 | 40 | 40 | 40 |
| second forming | | | | | |
| wheel (° C.) | | | | | |
| Temperature of | | | | | |
| third forming | 80 | 72 | 65 | 65 | 65 |
| wheel (° C.) | | | | | |
| Guiding wheel | 1 | 1 | 2.5 | 2 | 1 |
| (M/min) | | | | | |
| Extruding test | 1 | 2 | 3 | 4 | 5 |
| Board thickness | — | 1.8 | 0.8 | 1.4 | 2 |
| (mm) | | | | | |
| Appearance | adhesion | warpage | no | no | no |
| | | | abnormality | abnormality | abnormality |

TABLE 3
[Test result of light irradiation test
of Exemplary Example for 1,000 hours]

| | | | xenon |
|---|---|---|---|
| Wavelength | 313 nm | 340 nm | arc lamp |
| Light | 84.43 | 84.31 | 85.01 |
| transmittance | | | |
| (%) | | | |
| Haze (%) | 3.87 | 3.58 | 2.23 |

### Beneficial Effects of the Embodiment

In conclusion, in the method for producing a circuit board provided by the present disclosure, by virtue of “based on the total weight of the coating liquid being 100 wt %, a content of the polyurethane oligomer is between 30 wt % and 40 wt %, the content of the antistatic agent being between 5 wt % and 20 wt %, and the content of the solvent being between 40 wt % and 60 wt %” and “the antistatic agent including the first dispersant and the carbon nanotubes dispersed in the first dispersant, and the weight ratio between the carbon nanotubes and the first dispersant being between 99:1 and 99.9:0.1,” the conventional antistatic board having the optical property that is affected by the addition of inorganic antistatic agent having poor dispersion can be effectively improved.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An antistatic composite board, comprising:
a PET substrate;
a PET film formed on one side of the PET substrate; and
a coating layer formed by coating a coating liquid on one side of the PET film away from the PET substrate, wherein the coating liquid has a viscosity of between 20 cps and 40 cps, and the coating liquid includes:
a polyurethane oligomer;
an antistatic agent, wherein the antistatic agent includes a first dispersant and a plurality of carbon nanotubes dispersed in the first dispersant, and a weight ratio between the carbon nanotubes and the first dispersant is between 99:1 and 99.9:0.1; and
a solvent, wherein the solvent is propylene glycol methyl ether acetate (PMA);
wherein, based on a total weight of the coating liquid being 100 wt %, a content of the polyurethane oligomer is between 30 wt % and 40 wt %, a content of the antistatic agent is between 5 wt % and 20 wt %, and a content of the solvent is between 40 wt % and 60 wt %;
wherein the antistatic composite board has a light transmittance of greater than or equal to 84%, a haze of less than or equal to 4%, and a surface specific impedance of less than or equal to 1072.

2. The antistatic composite board according to claim 1, wherein a thickness of the PET substrate is between 1.5 mm and 2.5 mm, a thickness of the PET film is between 60 μm and 150 μm, and a thickness of the coating layer is between 2 μm and 8 μm.

3. The antistatic composite board according to claim 1, wherein a length of each of the carbon nanotubes is between 5 μm and 8 μm, and a diameter of each of the carbon nanotubes is between 1.2 nm and 2 nm.

4. The antistatic composite board according to claim 1, further comprising a photoinitiator and a second dispersant, wherein, based on the total weight of the coating liquid being 100 wt %, a content of the photoinitiator is between 0.1 wt % and 2 wt %, and a content of the second dispersant is between 0.1 wt % and 3 wt %, and wherein the photoinitiator is 1-hydroxycyclohexylbenzophenone, and the second dispersant is selected from the group consisting of styrene maleic anhydride copolymer and alkaline polymer pigment dispersant.

5. The antistatic composite board according to claim 1, wherein the antistatic composite board includes two PET films and two coating layers, the two PET films are disposed at two sides of the PET substrate, and each of the coating layers is disposed at one side of one of the PET films away from the PET substrate.

6. A method for producing an antistatic composite board, comprising:
a mixing process implemented by adding a polyurethane oligomer and an antistatic agent into a solvent and stirring at a stirring speed of between 600 rpm and 1,000 rpm for 5 minutes to 15 minutes to form a coating liquid, wherein the coating liquid has a viscosity of between 20 cps and 40 cps, and wherein the antistatic agent includes a first dispersant and a plurality of carbon nanotubes dispersed in the first dispersant, and a weight ratio between the carbon nanotubes and the first dispersant is between 99:1 and 99.9:0.1;
a coating process implemented by coating the coating liquid onto a PET film to form a coating layer on one side of the PET film; and
a thermal pasting process implemented by pasting the PET film having the coating layer formed thereon onto a PET substrate at a temperature of between 40° C. and 70° C., so as to form an antistatic composite board,
wherein the solvent is propylene glycol methyl ether acetate (PMA), and wherein, based on a total weight of the coating liquid being 100 wt %, a content of the polyurethane oligomer is between 30 wt % and 40 wt %, a content of the antistatic agent is between 5 wt % and 20 wt %, and a content of the solvent is between 40 wt % and 60 wt %,
wherein the antistatic composite board has a light transmittance of greater than or equal to 84%, a haze of less than or equal to 4%, and a surface specific impedance of less than or equal to 1072.

7. The method according to claim 6, wherein, in the mixing process, a photoinitiator and a second dispersant are added, wherein, based on the total weight of the coating liquid being 100 wt %, a content of the photoinitiator is between 0.1 wt % and 2 wt %, and a content of the second dispersant is between 0.1 wt % and 3 wt %, and wherein the photoinitiator is 1-hydroxycyclohexylbenzophenone, and the second dispersant is selected from the group consisting of styrene maleic anhydride copolymer and alkaline polymer pigment dispersant.

8. The method according to claim 6, wherein, after the coating process and before the thermal pasting process, the method further includes a photocuring process implemented by photocuring the PET film having the coating layer formed thereon with a light intensity of between 500 mJ/cm² and 1000 mJ/cm².

9. The method according to claim 6, wherein a length of each of the carbon nanotubes is between 5 μm and 8 μm, and a diameter of each of the carbon nanotubes is between 1.2 nm and 2 nm.

10. The method according to claim 6, wherein a thickness of the PET substrate is between 1.5 mm and 2.5 mm, a thickness of the PET film is between 60 μm and 150 μm, and a thickness of the coating layer is between 2 μm and 8 μm.
